(19) United States
(12) Patent Application Publication
(10) Pub. No.: US 2006/0235639 A1
(43) Pub. Date: Oct. 19, 2006

(54) METHOD FOR CALCULATING TEMPERATURE AS A FUNCTION OF TIME

(76) Inventor: Pietro Piazza, Palm Coast, FL (US)

Correspondence Address: Elsie C. Turner;Suite 204, 201 Park Place, Altamonte Springs, FL, 32701, US

(21) Appl. No.: 11/106,927

(22) Filed: Apr. 15, 2005

(51) Int. Cl. G06F 15/00

(52) U.S. Cl. 702/130

(57) ABSTRACT

A system and method is provided, comprising a sensor for monitoring surrounding temperature; a timer for generating clock data; a controller for reading temperature at predetermined intervals, storing temperature data and corresponding time data in memory and executing software commands; a data display; a calculator for calculating temperature as a function of time; and software containing commands, whereby a quantity, degree-time, is determined which reflects the amount of atmospheric heat present in a selected location during a selected period of time, and a value in degrees of temperature per unit of time for the period is determined, useful for comparison with values calculated for other localities, or anticipating power demands for heating and air conditioning.

### BACKGROUND OF THE INVENTION

This invention relates to methods and apparatus for measuring atmospheric temperature as a function of time, thus reflecting the total quantity of atmospheric heat during a selected interval of time in a selected location. Present-day weather reporting of temperatures around the globe typically includes minima and maxima of temperature within a period of time, usually twenty-four hours, without taking into account the rate of change between these two limits, or periods of time when the temperature remains unchanged. The website www.wunderground.com predicts temperatures at three-hour intervals for many locations and displays a “heat index” comprised of a variously colored map in which the colors correspond to temperature ranges. There are various systems for monitoring temperature over time such as U.S. Pat. No. 5,262,758 to Nam et al. which compares a current measured temperature with a predetermined temperature value, in order to activate an alarm when the measured temperature exceeds the predetermined value. Air conditioning and heating systems for buildings and vehicles utilize devices and methods to control the temperature of the air within. However these devices are not intended, nor do they provide, a means of quantifying the amount of heat in a local environment over a selected period of time. Thus it is an object of this invention to provide a system and method for recording the rate of change in temperature in a selected geographic area over selected periods of time as an indication of the total quantity of atmospheric heat present during the selected period. This measurement would be useful in comparing the relative amount of heat, or lack thereof, encountered in various geographic locations, or in determining the amount of power needs for heating heat or cooling buildings in a community.

### SUMMARY OF THE INVENTION

The system and method of this invention comprise a sensor for monitoring surrounding temperature; a timer for generating clock data; a controller for reading temperature at predetermined intervals, storing temperature data and corresponding time data in memory and executing software commands; a data display; a calculator for calculating temperature as a function of time; and software containing commands. Temperature is monitored at regular intervals during each selected period, is processed as the product of temperature multiplied by time and expressed in units of degree-time: degree-hours or degree-minutes(° t). The resulting quantity of degree-time is measured by the area under the curve on a graph displaying the temperature value on the Y-axis (i.e. ordinate) as a function of time, intervals of which are indicated on the X-axis (i.e. abscissa). It can also be displayed digitally. A value for degree-time per unit of time, the Piazza degree, is obtained by dividing the degree-time result for a particular period by the number of intervals in the period.

### BRIEF DESCRIPTION OF THE DRAWINGS

FIG. 1 is a graph of temperature as a function of time wherein the temperature increases uniformly;

FIG. 2 is a graph of temperature as a function of time wherein the rate of increase in temperature is variable;

FIG. 3 is a graph of temperature changes over time in three different hypothetical locations;

FIG. 4 is a block diagram of the degree-time values of the three locations of FIG. 3;

FIG. 5 is a graph of temperature changes over time wherein the temperature drops below zero;

FIG. 6 is a diagram of Piazza degree value of FIG. 5

FIG. 7 is a schematic diagram of the components of the device;

FIG. 8 is a flow-chart of the steps of the method of this invention.

### DETAILED DESCRIPTION OF THE PREFERRED EMBODIMENT

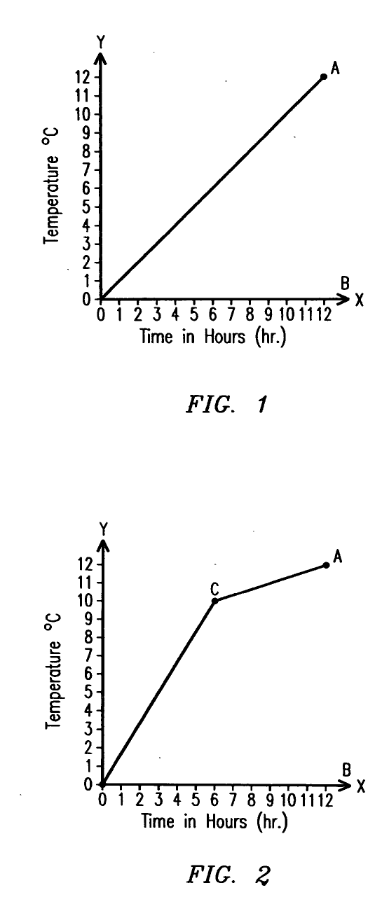

FIGS. 1 through 6. are graphs of hypothetical locations in which the minimum and maximum temperatures during a given period are the same, but the rate of change is different. These graphs use straight lines to simplify the calculations of the degree-time values, it being understood that in reality temperatures can change at varying and irregular rates which would be reflected in irregular curves. In both FIGS. 1 and 2, the minimum temperature is zero (0° C.) at the beginning of a twelve-hour period, and twelve degrees (12° C.) at the end thereof, but the rate of increase is different. In FIG. 1, the temperature rises at a constant rate, whereas in FIG. 2, the temperature rises initially at a faster rate from the beginning of hour one to 10° C. at the end of hour six, then more gradually to 12° C. at the end of hour 12. It can be seen that the area under each of these graphs is not the same. In FIG. 1 it is a simple triangle, the area of which is (12×12)/2=72 units of degree-time (72° t), whereas the area under the graph in FIG. 2 is that of a quadrangular polygon equivalent to a triangle and a rectangular trapezoid. The areas of these latter figures are, respectively, (6×10)/2=30° t. and ((10+12)/2)×6=66° t. Thus the area of the quadrangular polygon is 30° t+66° t.=96° t.

These examples demonstrate, in mathematical terms, that even though the values of minimum and maximum temperatures are the same, they have different degree-time values. These degree-time values reflect a difference in the quantity of atmospheric heat present over the selected time period in the two hypothetical locations. It is useful in comparing relative heat quantities for the two areas to divide the degree-time number by the number of hours involved to obtain a value of temperature per time interval (Piazza degree) for each location for the selected time period. Thus the location of FIG. 1 has a Piazza degree of 72° hrs/12 hrs=6° P whereas the location of FIG. 2 has a Piazza degree of 96° hrs./12=8° P. One can then say the second location is warmer than the first, having one-third more atmospheric heat.

Approximately the same resulting Piazza degree will be achieved whether the interval between temperature measurements is a minute or longer, although greater accuracy is achieved with smaller intervals. Assume that in FIG. 1, the interval between temperature measurements is one (1) minute rather than one hour. The area under the graph will be calculated as ½(12°*720 min)=4320 degree-minutes. The Piazza degree, is thus 4320/720=6°.

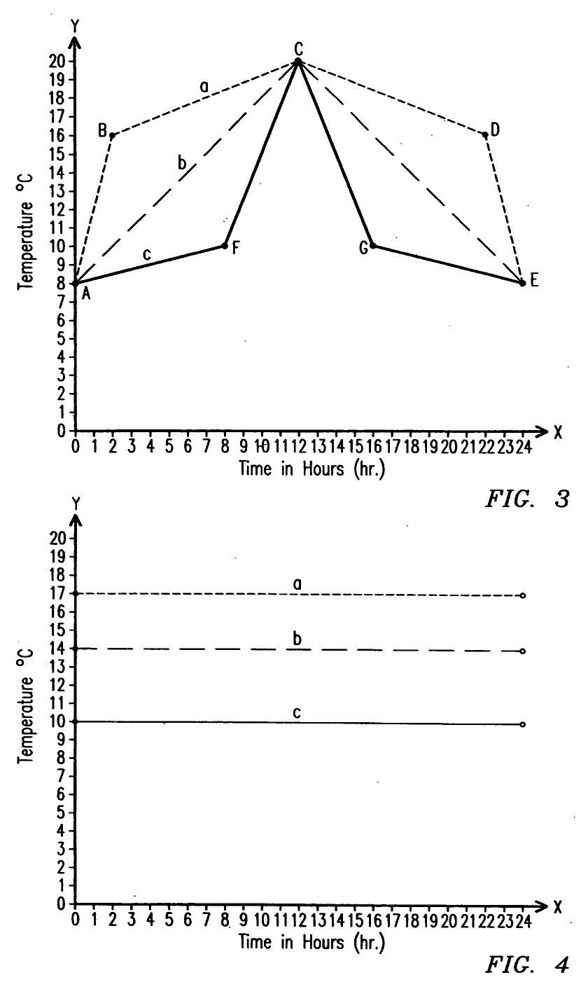

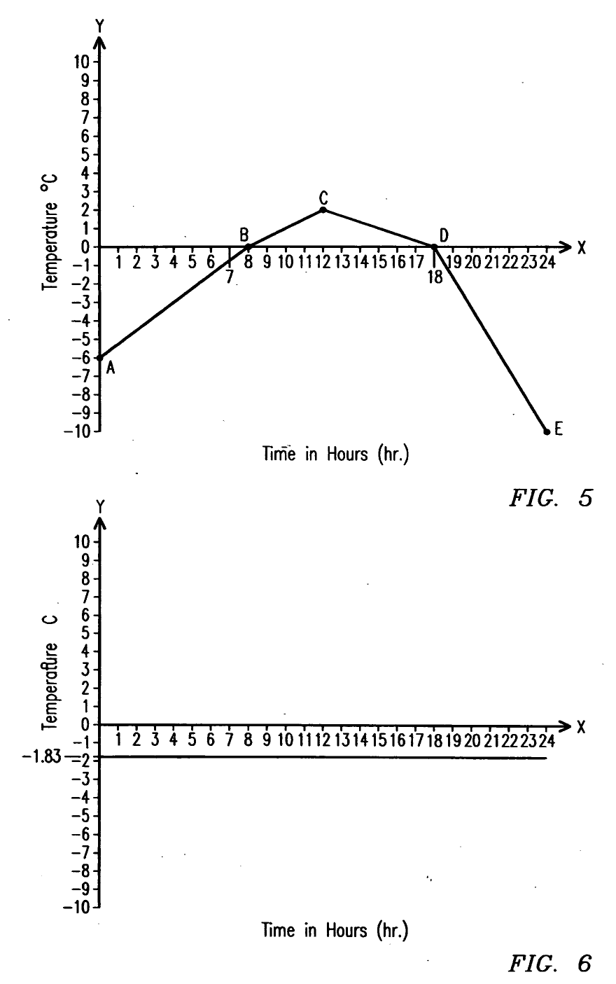

FIG. 3 illustrates the foregoing concepts in one graph of temperature over time at three hypothetical locations, a, b, and c. At each location, the temperature is 8° at the beginning of hour one, rises to 20° at the end of the twelfth hour, and falls back to 8° at the end of the twenty-fourth hour. However at a, the curve rises to 16°, point B, at the end of hour 2, then rises to 20°, point C, at the end of the twelfth hour, drops to 16° after ten hours, then back to 8°, point E, at the end of the period. At b, the rise and fall are at a constant rate up to point C and back down to point E. At c, the temperature goes up slowly to 10° at the end of the eighth hour, point F, then up to point C, back down to 10° at the end of the sixteenth hour, point G, and then back down to point E. By calculating the areas under each curve, then dividing the resulting degree-times by twenty-four hours as shown in FIG. 4, one obtains a value (Piazza degree) of 17° for City a, 14° for City b, and 10° for City c. One can then say that City a is the warmest, City c is the coldest, and City b is in between the other two, which would not be evident from the usual practices of reporting minimum and maximum temperatures in use today.

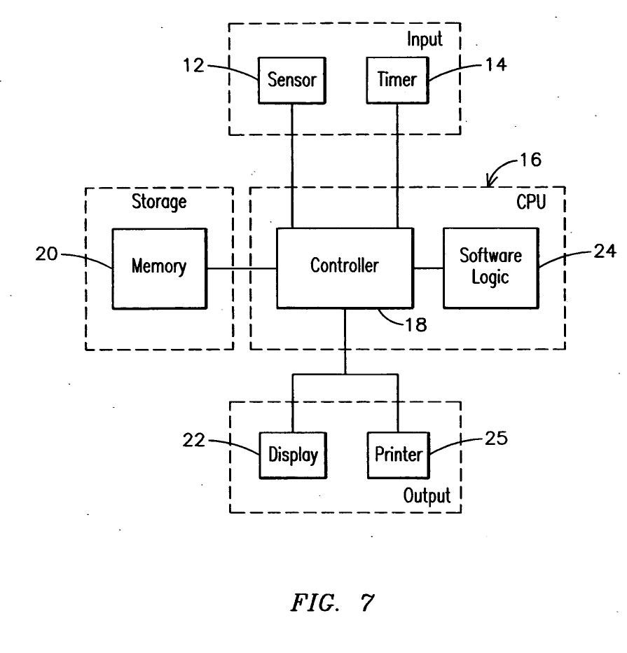

FIG. 5 illustrates the application of the degree-time calculation to a graph of temperature beginning at −6° C. at point A, rising to 0° C. at point B, then 2° C. at point C, then falling back to 0° C. at point D, and dropping to −10° C. after twenty-four hours. The area under the graph from A to B is −24°, from B to C is +4°, from C to D is +6°, and from D to E is −30°, for a total degree-time value of −44° for the twenty-four hour period. The degree-time value per interval, or Piazza degree, is illustrated in FIG. 6, and is −1.8333°. C, a negative value even though the maximum temperature for the period is positive.

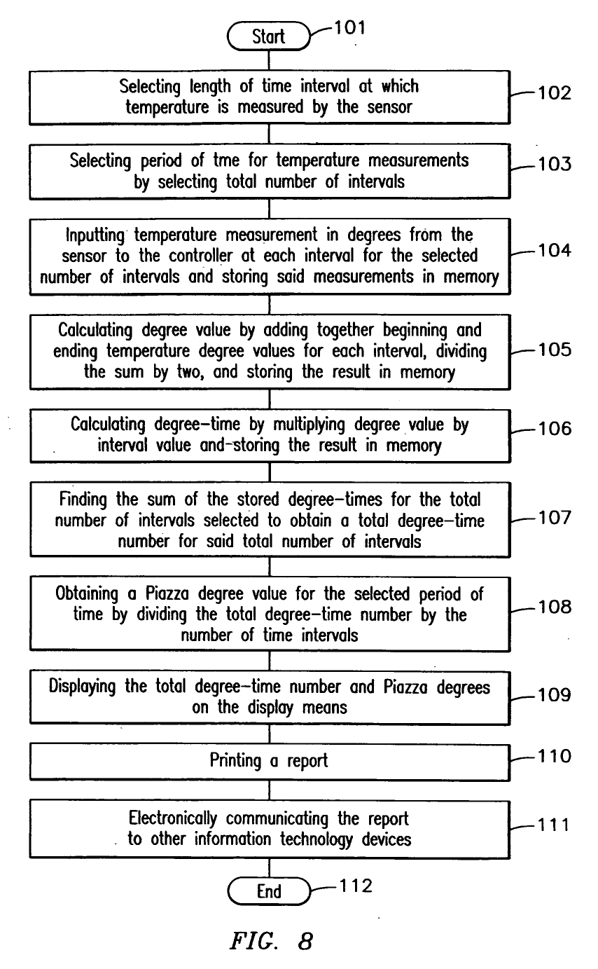

The device or system for recording temperature at predetermined regular intervals and calculating degree-times is shown schematically in FIG. 7. The device 10 comprises a sensor 12 for measuring surrounding atmospheric temperature, a timer 14 for generating clock data, a central processing unit (CPU) 16 having a controller 18 for reading temperature at predetermined intervals, and a memory 20 for storing temperature data and corresponding time data in memory and executing software commands, a data display 22, a software program 24 for calculating temperature as a function of time in units of degree-time, and computing a Piazza number representing the degree-time value per interval for a selected time period per location, and a printer 25 for printing reports. Optionally the system could have transmitting capabilities, either through a network or an internet service provider.

The method of calculating temperature as a function of time, in units of degree-time, and determining the Piazza degree, is comprised of the following steps performed according to a software program:

101: start;

102: input length of time for each interval at which temperature is measured,

103: input total number of intervals in continuous succession during which temperature will be measured;

104: input temperature from sensor at each interval for the selected period of time, i.e., number of intervals in continuous succession;

105: calculate degree values by calculating the area under the temperature curve for each individual interval of time using the formula for area of a trapezoid; then store the results in memory;

106: find the sum of all stored degree-time interval values during selected period of time and store in memory;

107: divide sum of products by number of time intervals to obtain Piazza degree for selected period and store in memory;

108 display total degree-time value and Piazza degree on monitor;

109: print report of sum of degree-time products and Piazza degree.

110: display, print degree-time and Piazza degrees of other selected periods.

111: (optional) transmit report to other locations;

112: end.

The system and method of this invention may utilize an interval of any length for taking temperature measurements, such as a minute, an hour, or multiples thereof. The smaller the interval, the greater the accuracy in the graph of temperature versus time. However, the value of each interval, for purposes of calculation of degree-time, is one (1) on the x-axis. The area under the temperature-time graph of an interval or number of intervals of time can be calculated by the following equation:
n((Y₁+Y₂)/2)
where n is the number of intervals on the X-axis, Y₁ and Y₂ are the temperature values at the beginning and end of each interval, and the temperature line between Y₁ and Y₂ is assumed to be straight Thus when n equals one (1), the equation becomes simply (Y₁+Y₂)/2. A computer program can utilize this equation for calculating the degree-time for each interval in a selected period of time, adding all the degree-times to obtain a total for the selected period, and calculating the Piazza degree value by dividing the total by the number of intervals. The temperature scale can be Fahrenheit, Celsius, or absolute (Rankin or Kelvin).

1-6. (canceled)

7. A method of calculating temperature as a function of time, using a system comprised of a sensor for measuring atmospheric temperature, a timer for generating clock data, a controller operatively connected to said temperature sensor and said timer, said controller having means for reading temperature measurements at predetermined time intervals and having means for storage of commands and data, data-processing means for calculating said temperature measurements as a function of time and generating a report thereof, display means connected to said controller for displaying said report, printing means for printing said report, and electronic communication means for transmitting said report to other information technology devices, said method comprising the following steps:
selecting length of time interval at which temperature is measured by the sensor;
selecting period of time for temperature measurements by selecting total number of intervals;
inputting temperature measurement in degrees from the sensor to the controller at each interval for the selected number of intervals and storing said measurements in memory;
calculating degree value by adding together beginning and ending temperature degree values for each interval, dividing the sum by two, and storing the result in memory;
calculating degree-time by multiplying degree value by interval value and storing the result in memory;
finding the sum of the stored degree-times for the total number of intervals selected to obtain a total degree-time number for said total number of intervals;
obtaining a Piazza degree value for the selected period of time by dividing the total degree-time number by the number of time intervals
generating a report by displaying the total degree-time number and Piazza degrees on the display means.

8. The method according to claim 7 further comprising the step of printing the report generated in claim 7.

9. The method according to claim 7 further comprising the step of electronically communicating the report generated in claim 7 to other information technology devices.
